(19) United States
(12) Patent Application Publication
(10) Pub. No.: US 2010/0315407 A1
(43) Pub. Date: Dec. 16, 2010

(54) Display control circuit

(75) Inventor: Makoto Miura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/662,773

(22) Filed: May 3, 2010

(30) Foreign Application Priority Data
Jun. 12, 2009 (JP) 2009-141380

(51) Int. Cl. G06F 3/038

(52) U.S. Cl. 345/214

(57) ABSTRACT

A display control circuit for a display includes a plurality of amplifiers connected to data lines of a display panel, the plurality of amplifiers being configured to apply a gray-scale voltage to the data lines when a bias current is supplied, and a control circuit that supplies a bias current to the amplifiers, wherein the control circuit detects an operating state of at least one amplifier among the plurality of amplifiers that operates by the bias current in a first time region, and causes the plurality of amplifiers to operate by supplying the bias current for a predetermined period according to the detection result in a second time region after the first time region.

### INCORPORATION BY REFERENCE

This application is based upon and claims the benefit of priority from Japanese patent application No. 2009-141380, filed on Jun. 12, 2009, the disclosure of which is incorporated herein in its entirety by reference.

### BACKGROUND

1. Field of the Invention

The present invention relates to a display control circuit.

2. Description of Related Art

As mobile display devices have become more widespread, it has been required to prolong the battery operation life of the liquid crystal display devices. As a result, the demand for low power operation of liquid crystal display devices has been also growing. To solve such demand for reducing the power consumption in liquid crystal display devices, it is effective to reduce the power consumption of the output circuit of the display control circuit, which consumes large electrical power in the liquid crystal display device. The output circuit of a display control circuit has been required to consume less electrical power while being capable of driving the source line load of the display device within a certain time period.

FIG. 13 shows an output circuit 1 of a display control circuit (drive circuit for display) in prior art disclosed in Patent document 1 (Japanese Patent No. 3847207). As shown in FIG. 13, the output circuit 1 includes output units OP1 to OP528, a bias current control circuit 11, a switch change signal generation circuit 12, and an amplifier control signal selection circuit 13. The output units OP1 to OP528 include the respective amplifiers AMP 1 to AMP528 and switch circuits SWA1 to SWA528 and SWB1 to SWB528.

FIG. 14 shows a configuration of the amplifier control signal selection circuit 13. As shown in FIG. 14, the amplifier control signal selection circuit 13 includes a comparison voltage generation circuit 31, a comparison circuit 32, and a multiplexer 33.

The comparison voltage generation circuit 31 is composed of a band gap reference circuit. Further, it outputs predetermined comparison voltages Vr1, Vr2 and Vr3 such that the voltage value becomes higher successively as expressed as Vr1<Vr2<Vr3 so as to correspond to different levels of the bias voltage VBIAS from the low level to the high level. The bias voltage VBIAS is supplied from the bias current control circuit 11.

The comparison circuit 32 compares the bias voltage VBIAS, which is the output potential of the bias current control circuit 11, with each of the comparison voltages Vr1, Vr2 and Vr3. Then, it generates 2-bit selection signals SB and SA as its comparison result. For example, when Vr1≧VBIAS, it outputs [SB, SA]=[0, 0]; when Vr2≧VBIAS>Vr1, it outputs [0, 1]; when Vr3≧VBIAS>Vr2, it outputs [1, 0]; and when VBIAS>Vr3, it outputs [1, 1]. FIG. 15 shows a configuration of the comparison circuit 32. As shown in FIG. 15, the comparison circuit 32 includes comparators 21 to 23, an EXNOR circuit 24, AND circuits 25 and 26, a delay circuit 27, a 2-bit data register 28, and a 2-bit latch circuit 29.

The multiplexer 33 selects one of amplifier control signals VS0, VS1, VS2 and VS3 having different pulse widths, which are supplied based on the selection signals SB and SA from a control circuit (not shown), and outputs the selected signal as an amplifier control signal VS.

For example, when the selection signals SB and SA are expressed as “[SB, SA]=[0, 0]”, it outputs the signal VS0; when the signals SB and SA are [0, 1], it outputs the signal VS1; when the signals SB and SA are [1, 0], it outputs the signal VS2; and when the signals SB and SA are [1, 1], it outputs the signal VS3.

The amplifier control signals VS0, VS1, VS2 and VS3 are defined in advance such that the pulse width becomes narrower successively so as to correspond to different levels of the bias voltage VBIAS from the low level to the high level. The bias voltage VBIAS is supplied from the bias current control circuit 11. The relation of this pulse width is expressed as VS0>VS1>VS2>VS3.

Next, operations of the output circuit 1 having the above-described configuration are explained with reference to FIG. 16. At a time t1, a strobe signal STB, which is supplied to a data-side drive circuit at intervals of one horizontal synchronization cycle, rises to a high level. At this point, the switch change signal SWA remains at a low level, and the switch change signal SWS falls from a high level to a low level. As a result, all of the switch circuits SWA1 to SWA528 and SWB1 to SWB528 are tuned off.

Assume that selection signals [SB, SA]=[0, 1] were taken in advance into the data resister 28 in the comparison circuit 9. In synchronization with the change of the strobe signal STB to a high level at the time t1, the selection signals [SB, SA]=[0, 1] are taken into the latch 29. Then, they are retained until a time t5 at which the strobe signal STB rises to a high level again. In this way, the multiplexer 33 becomes a state in which it selects the signal VS1 as the amplifier control signal VS.

Next, the amplifier control signals VS0, VS1, VS2 and VS3 rise to a high level at a time t2. As a result, the amplifier control signal VS1 rises to a high level as the amplifier control signal VS supplied to the bias current control circuit 2. Therefore, a bias current is supplied to each of the amplifiers AMP1 to AMP528, and each of the amplifiers thereby becomes an operating state.

At a time t3, which is delayed from the time t2 by a predetermined time, the switch change signal SWA rises to a high level and the switch circuits SWA1 to SWA528 are thereby turned on. As a result, gray-scale voltages D1 to D528 supplied from a gray-scale voltage selection circuit (not shown) are amplified at the respective amplifiers AMP1 to AMP528. After that, they are applied to the respective data lines of the color liquid crystal panel as data red signals, data green signals, and data blue signals S1 to 5528.

At this point, the bias voltage VBIAS is compared with each of the comparison voltages Vr1, Vr2 and Vr3 in the comparators 21 to 23. Logical operation processing is performed on their comparison results by the XNOR circuit 24 and AND circuits 25 and 26, and the resulting values are supplied to the data register 28. Then, the amplifier control signal VS0, which rises to a high level at the time t2, is supplied to the data register 28 through a delay circuit 27 in the comparison circuit 32. The amplifier control signal VS0 rises to a high level after delayed by a predetermined time from the time t2 by the delay circuit 27. In synchronization with the rising edge of this delayed signal, the outputs of the AND circuits 25 and 26 are taken into the data register 28 as selection signals SB and SA.

Next, when the amplifier control signal VS1 falls to a low level at a time t4, the supply of the bias current to each of the amplifiers AMP1 to AMP528 is stopped. As a result, the amplifiers AMP1 to AMP528 become a non-operating state. Then, at roughly the same moment as the amplifier control signal VS1 falls to a low level, the switch change signal SWA falls to a low level. As a result, the switch circuit SWA1 to SWA528 are turned off. With this, the switch change signal SWS rises to a high level, and the switch circuits SWB1 to SWB528 are thereby turned on. As a result, the gray-scale voltages D1 to D528 supplied from the gray-scale voltage selection circuit are directly applied to the respective data lines of the color liquid crystal panel as data red signals, data green signals, and data blue signals S1 to S528 through the switch circuit SWB1 to SWB5 without passing through the respective amplifiers AMP1 to AMP528.

Next, the strobe signal STB rises to a high level at a time T5. Then, the switch change signal SWS falls to a low level. As a result, all the switch circuit SWA1 to SWA528 and SWB1 to SWB528 are tuned off. Further, at this point, in synchronization with the change of the strobe signal STB to a high level at the time t5, the selection signals SB and SA are taken into the latch circuit 29 and retained there until a time at which the strobe signal STB rises to a high level again in a manner similar to that described above.

### SUMMARY

Note that the output circuit 1 determines the writing capability of the amplifiers AMP1 to AMP528, which is the last stage of the display control circuit, by monitoring with the amplifier control signal selection circuit 13, which is the preceding stage thereof. Therefore, the writing time cannot be accurately detected, and therefore it is necessary to add an amount equivalent to the variations in the writing time of the amplifier to the operating time. Therefore, the shortest operating time for the writing operation of the amplifier cannot be obtained, and thus posing a problem that the current consumption cannot be minimized.

In a first exemplary aspect of the invention, a display control circuit for a display includes: a plurality of amplifiers connected to data lines of a display panel, the plurality of amplifiers being configured to apply a gray-scale voltage to the data lines when a bias current is supplied; and a control circuit that supplies a bias current to the amplifiers, wherein the control circuit detects an operating state of at least one amplifier among the plurality of amplifiers that operates by the bias current in a first time region, and causes the plurality of amplifiers to operate by supplying the bias current for a predetermined period according to the detection result in a second time region after the first time region.

The display control circuit in accordance with an exemplary aspect of the present invention can detect an operating time equivalent to the variations of the amplifier by detecting an operating state of the amplifier that operates by the bias current in the first time region. Further, since the display control circuit causes the amplifier to operate by supplying the bias current for a predetermined period according to its detection result in the second time region, it can determine the optimal operating period for the amplifier.

A display control circuit in accordance with an exemplary aspect of the present invention can reduce the consumption power.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a configuration of a display control circuit in accordance with a first exemplary embodiment of the present invention;

FIG. 2 shows a configuration of an output stage fluctuation detection circuit in accordance with a first exemplary embodiment of the present invention, and its connection relation with an amplifier;

FIG. 3 is an example of a configuration of a detection circuit of an output stage fluctuation detection circuit in accordance with a first exemplary embodiment of the present invention;

FIG. 4 is a timing chart for explaining operations of an output stage fluctuation detection circuit and amplifier in accordance with a first exemplary embodiment of the present invention;

FIG. 5 is a timing chart for explaining operations of a display control circuit in accordance with a first exemplary embodiment of the present invention;

FIG. 6 is a configuration of a display control circuit in accordance with a second exemplary embodiment of the present invention;

FIG. 7 is an example of a configuration of a bias current control circuit in accordance with a second exemplary embodiment of the present invention;

FIG. 8 is a timing chart for explaining operations of a display control circuit in accordance with a second exemplary embodiment of the present invention;

FIG. 9 is a timing chart for explaining operations of a display control circuit in accordance with a second exemplary embodiment of the present invention;

FIG. 10 is a timing chart for explaining operations of a display control circuit in accordance with a second exemplary embodiment of the present invention;

FIG. 11 is a configuration of a display control circuit in accordance with a third exemplary embodiment of the present invention;

FIG. 12 is a timing chart for explaining operations of a display control circuit in accordance with a third exemplary embodiment of the present invention;

FIG. 13 is a configuration of a display control circuit in prior art;

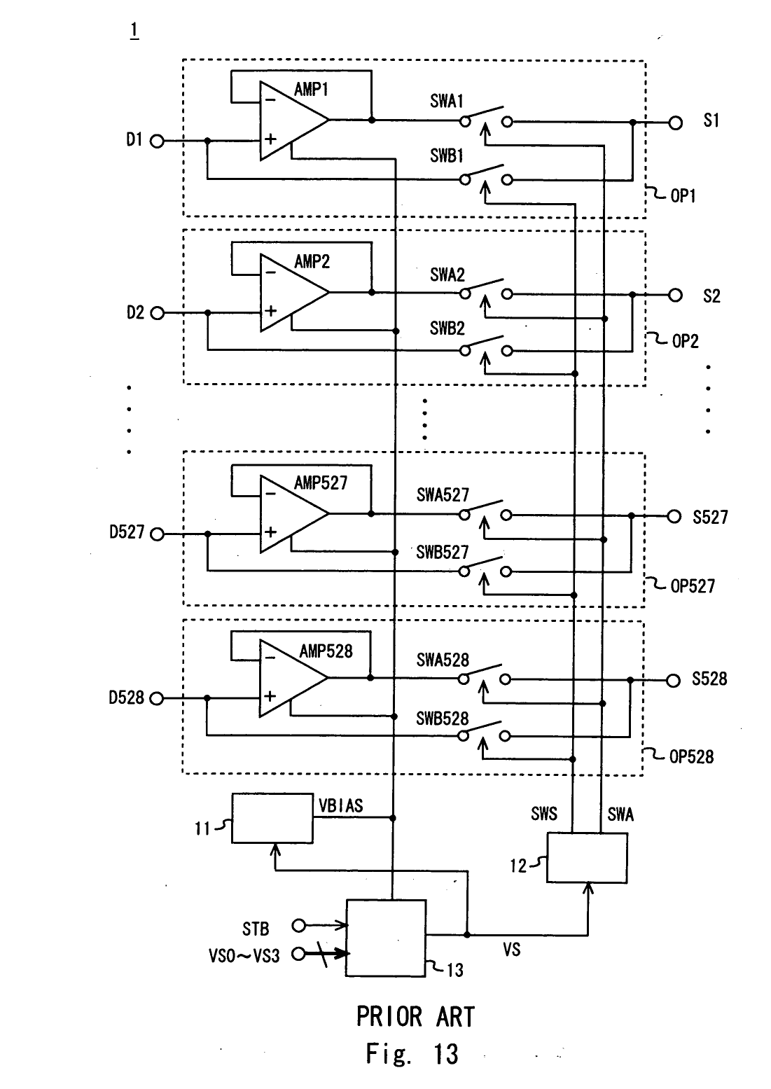

FIG. 14 is a configuration of a bias current control circuit in prior art;

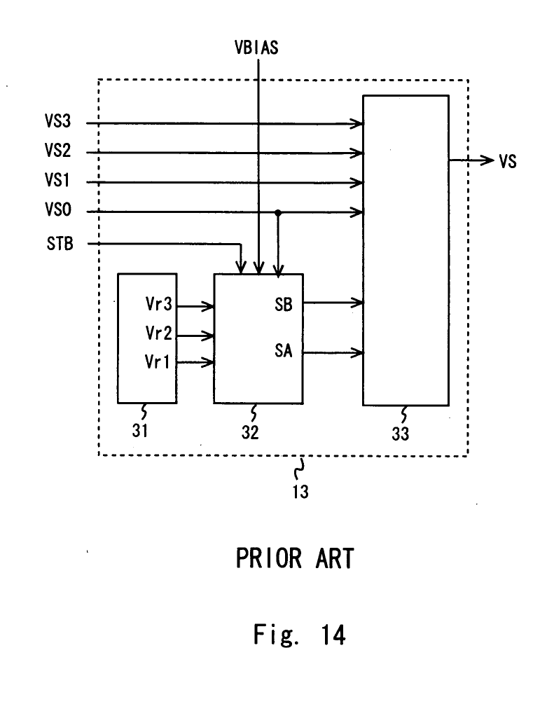

FIG. 15 is a configuration of a switch change signal generation circuit in prior art; and

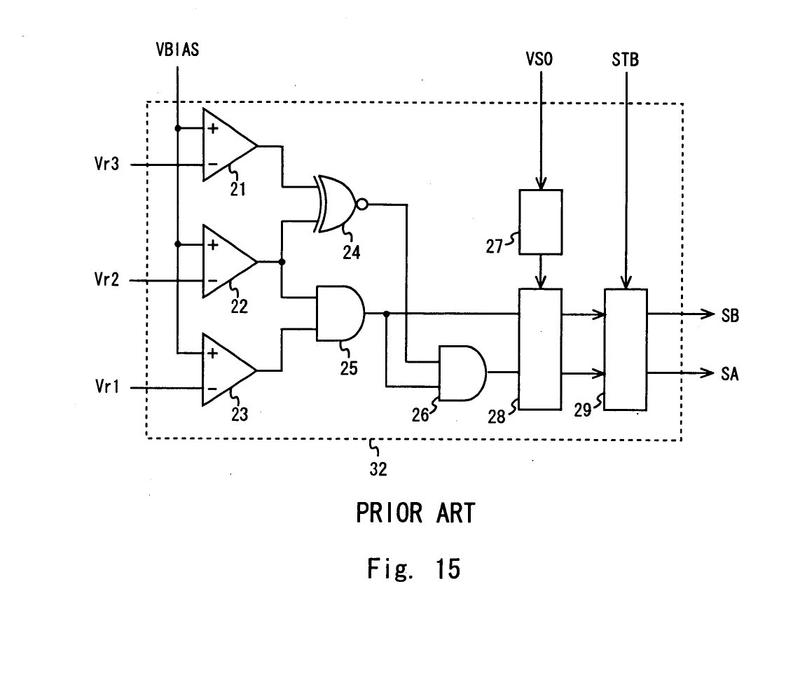

FIG. 16 is a timing char for explaining operations of a display control circuit in prior art.

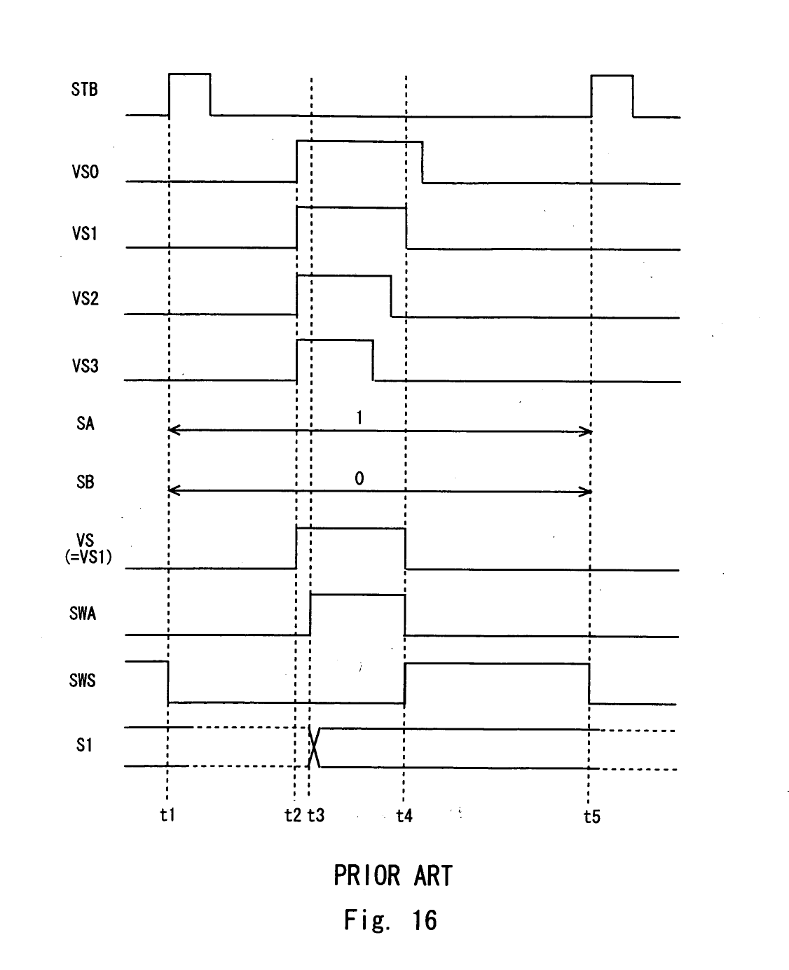

### DETAILED DESCRIPTION OF THE EXEMPLARY EMBODIMENTS

### First Exemplary Embodiment

A specific first exemplary embodiment to which the present invention is applied is explained hereinafter with reference to the drawings. In this first exemplary embodiment, the present invention is applied to a display control circuit (drive circuit for display) of a liquid crystal display device.

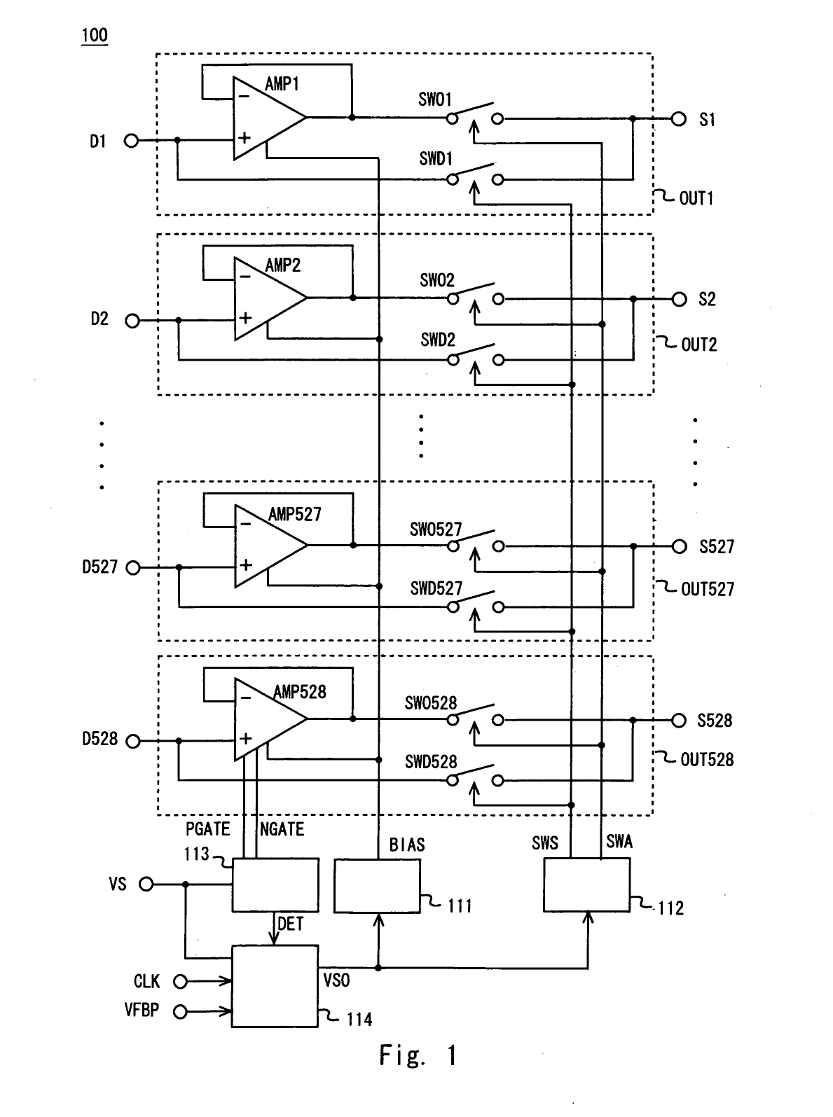

FIG. 1 shows an example of a configuration of a display control circuit 100 in accordance with this exemplary embodiment. Note that an example of a display control circuit capable of coping with 528 data lines (176×3 (red, green and blue)=528) of a color liquid crystal panel whose resolution is 176×220 pixels is described in this exemplary embodiment.

As shown in FIG. 1, a display control circuit 100 includes output units OUT1 to OUT528, a bias current control circuit 111, a switch change signal generation circuit 112, an output stage fluctuation detection circuit 113, and a retention control circuit 114. The output units OUT1 to OUT528 includes respective amplifiers AMP1 to AMP528 and switch circuits SWO1 to SWO528 and SWD1 to SWD528.

The inverting input terminals of the amplifiers AMP1 to AMP528 are connected to their own output terminals, and the non-inverting terminals thereof are connected to data input terminals D1 to D528. Further, each of the output terminals of the amplifiers AMP1 to AMP528 is also connected to one of the terminals of respective one of the switch circuits SWO1 to SWO528. Note that for the sake of convenience, the signs “D1” to “D528” indicate, in addition to the names of the terminals, data signals input to the respective terminals. Further, each of the data input signals D1 to D528 is one of data red signals, data green signals, and data blue signals corresponding to the data lines of the color liquid crystal panel. Further, a bias current is supplied from the bias current control circuit 111 to each of the amplifiers AMP1 to AMP528. By supplying this bias current, they start to operate.

One of the terminals of each of the switch circuits SWO1 to SWO528 is connected to the output terminal of the respective one of amplifiers AMP1 to AMP528, and the other terminal thereof is connected to the respective one of data output terminals S1 to 5528. Note that for the sake of convenience, the signs “S1” to “S528” indicate, in addition to the names of the terminals, data signals output from the respective terminals. The On-Off state of each of the switch circuits SWO1 to SWO528 is controlled according to the switch change signal SWA. For example, when the signal level of the switch change signal SWA is high, it becomes an On-state.

One of the terminals of each of the switch circuits SWD1 to SWD528 is connected to respective one of the data input terminals D1 to D528, and the other terminal thereof is connected to respective one of data output terminals S1 to S528. The On-Off state of each of the switch circuits SWD1 to SWD528 is controlled according to the switch change signal SWS. For example, when the signal level of the switch change signal SWS is high, it becomes an On-state. Note that the data output terminals S1 to S528 are connected to the respective data lines of the color liquid crystal panel.

The retention control circuit 114 receives a detection result signal DET, an amplifier control signal VS, a display clock CLK, and a mode signal VFBP. Then, it outputs an amplifier control signal VSO according to these input signals. The detection result signal DET is a signal output from the output stage fluctuation detection circuit 113 (which is described later). The amplifier control signal VS is a signal that, when at a high level, brings about a state in which a bias current can be supplied to the amplifiers AMP1 to AMP528. This amplifier control signal VS is supplied from a control circuit (not shown) located inside or outside the display control circuit 100. The display clock CLK is an internal clock used inside the display control circuit 100. The mode signal VFBP is a signal used to perform switching between a non-display region and a display region. Note that the “non-display region” is a period in which the color liquid crystal panel pixel(s) connected to the output unit 528 is not driven. On the other hand, the “display region” is a period in which the color liquid crystal panel pixel(s) connected to the output unit 528 is driven. Note that the mode signal VFBP is a signal that becomes a high level in the non-display region and becomes a low level in the display region. Further, the retention control circuit 114 includes a counter and the like, and counts the display clock CLK. Furthermore, it can store its count information.

A bias voltage signal BIAS, which is the output signal of the bias current control circuit 111, is controlled by the amplifier control signal VSO from the retention control circuit 114. Further, the bias current control circuit 111 changes the supply of the bias current to the amplifiers AMP1 to AMP528 between a supplying state and a suspended state based on the signal level of the amplifier control signal VSO. For example, when the amplifier control signal VSO is at a high level, it supplies a bias current to each of the amplifiers AMP1 to AMP528, whereas when the amplifier control signal VSO is at a low level, it suspends the supply of the bias current to each of the amplifiers AMP1 to AMP528.

The switch change signal generation circuit 112 (switch control circuit) controls the signal level of the switch change signals SWA and SWS, which are its output signals, according to the amplifier control signal VSO from the retention control circuit 114. The switch change signal SWA is output to the switch circuits SWO1 to SWO528. The switch change signal SWS is output to the switch circuits SWD1 to SWD528.

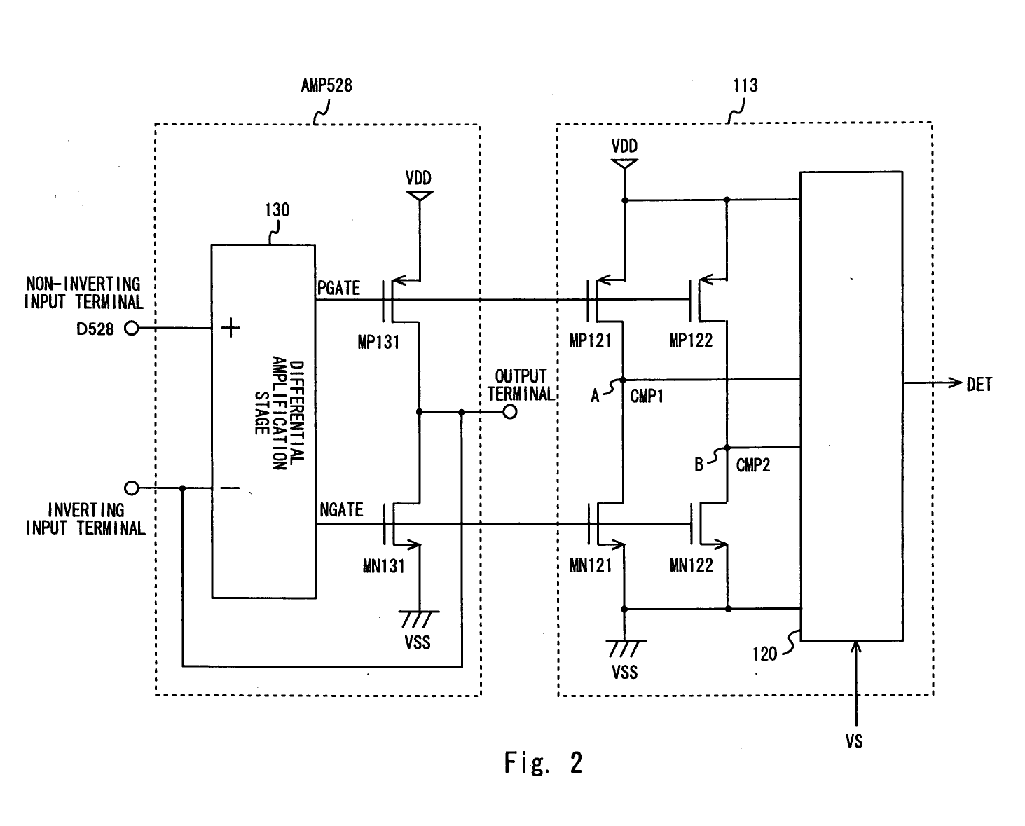

The internal circuit of the output stage fluctuation detection circuit 113 is connected to the internal circuit of the amplifier AMP528. Further, it outputs a detection result signal DET according a signal(s) transmitted in the internal circuit of the amplifier AMP528. FIG. 2 shows a configuration of the output stage fluctuation detection circuit 113. FIG. 2 also shows a configuration of the amplifier AMP528 and the connection relation between the internal circuits of the output stage fluctuation detection circuit 113 and the amplifier AMP528.

As shown in FIG. 2, the output stage fluctuation detection circuit 113 (detection circuit) includes PMOS transistors MP121 and MP122, NMOS transistors MN121 and MN122, and an internal detection circuit 120. The source of the PMOS transistor MP121 is connected to a power-supply voltage terminal VDD, and the drain is connected to a node A. The source of the PMOS transistor MP122 is connected to the power-supply voltage terminal VDD, and the drain is connected to a node B. A gate control signal PGATE (which is described later) is input from the amplifier AMP528 to the gates of the PMOS transistors MP121 and MP122.

The drain of the NMOS transistor MN121 is connected to the node A, and the source is connected to a ground voltage terminal VSS. The drain of the NMOS transistor MN122 is connected to the node B, and the source is connected to the ground voltage terminal VSS. A gate control signal NGATE (which is described later) is input from the amplifier AMP528 to the gates of the NMOS transistors MN121 and MN122.

The potential levels at the nodes A and B are input to the detection circuit 120 as operation signals CMP1 and CMP2 respectively. The detection circuit 120 receives the operation signals CMP1 and CMP2 and the amplifier control signal VS, and outputs a detection result signal DET according to these signals.

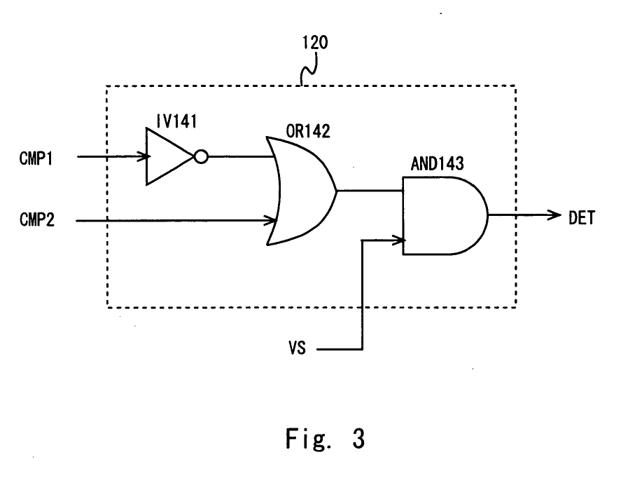

FIG. 3 shows an example of a configuration of the detection circuit 120. As shown in FIG. 3, the detection circuit 120 includes an inverter circuit IV141, an OR circuit OR142, and an AND circuit AND143. The inverter circuit IV141 receives the operation signal CMP1 and outputs a logically-inverted signal to the OR circuit OR142. The OR circuit OR142 receives a signal obtained by logically inverting the operation signal CMP1 from the inverter circuit IV141, and also receives the operation signal CMP2. Then, it outputs a result obtained by performing a logical sum operation of these signals. The AND circuit AND143 receives the result signal of the operation output from the OR circuit OR142 and the amplifier control signal VS. Then, it outputs a result obtained by performing a logical product operation of these signals as a detection result signal DET.

With the configuration described above, the detection result signal DET, which is the output of the detection circuit 120, is fixed at a low level when the amplifier control signal VS is at a low level. Further, when the amplifier control signal VS, the operation signal CMP1, and the operation signal CMP2 are at a high level, a high level, and a low level respectively, the detection result signal DET becomes a low level. When the amplifier control signal VS, the operation signal CMP1, and the operation signal CMP2 are at a low level, a high level, and a high level respectively, the detection result signal DET becomes a high level. When the amplifier control signal VS, the operation signal CMP1, and the operation signal CMP2 are at a high level, a low level, and a high level respectively, the detection result signal DET becomes a high level. When the amplifier control signal VS, the operation signal CMP1, and the operation signal CMP2 are at a high level, a low level, and a low level respectively, the detection result signal DET becomes a high level.

The amplifier AMP528 includes a differential amplification stage 130, a PMOS transistor MP131, and an NMOS transistor MN131. The differential amplification stage 130 outputs gate control signals PGATE and NGATE according to signals input to the non-inverting input terminal and inverting input terminal. The source of the PMOS transistor MP131 is connected to the power-supply voltage terminal VDD, and the drain is connected to an output terminal. Further, the gate control signal PGATE is input to the gate of the PMOS transistor MP131. The drain of the NMOS transistor MN131 is connected to the output terminal, and the source is connected to the ground voltage terminal VSS. Further, the gate control signal NGATE is input to the gate of the NMOS transistor MN131.

Furthermore, the output terminal and the inverting input terminal of the amplifier AMP528 are connected to each other, and thereby constituting a voltage follower. Therefore, if the potential of the signal input to the non-inverting input terminal is changed to the high-potential side, it tries to change the potential at the output terminal to the high-potential side so that the non-inverting input terminal and inverting input terminal have the same potential. Accordingly, the gate control signal PGATE falls so that the PMOS transistor MP131 is turned on. On the other hand, if the potential of the signal input to the non-inverting input terminal is changed to the low-potential side, it tries to change the potential at the output terminal to the low-potential side so that the non-inverting input terminal and inverting input terminal have the same potential. Therefore, the gate control signal NGATE rises so that the NMOS transistor MN131 is turned on.

As described above the gate control signal PGATE output from the differential amplification stage 130 is input to the gate of the PMOS transistor MP131 of the amplifier AMP528 and gates of the PMOS transistors MP121 and MP122 of the output stage fluctuation detection circuit 113. Similarly, the gate control signal NGATE output from the differential amplification stage 130 is input to the gate of the NMOS transistor MN131 of the amplifier AMP528 and gates of the NMOS transistors MN121 and MN122 of the output stage fluctuation detection circuit 113. Note that the gate sizes of the PMOS transistors MP121, MP122 and MP131 and NMOS transistors MN121, MN122 and MN131 are adjusted so that the relation expressed by the equations (1) and (2) shown below is satisfied.

(MP121/MP131)>(MN121/MN131) Equation (1)

(MP122/MP131)<(MN122/MN131) Equation (2)

Note that it is also possible to regard all of these bias current control circuit 111, output stage fluctuation detection circuit 113, and retention control circuit 114 as a single control circuit.

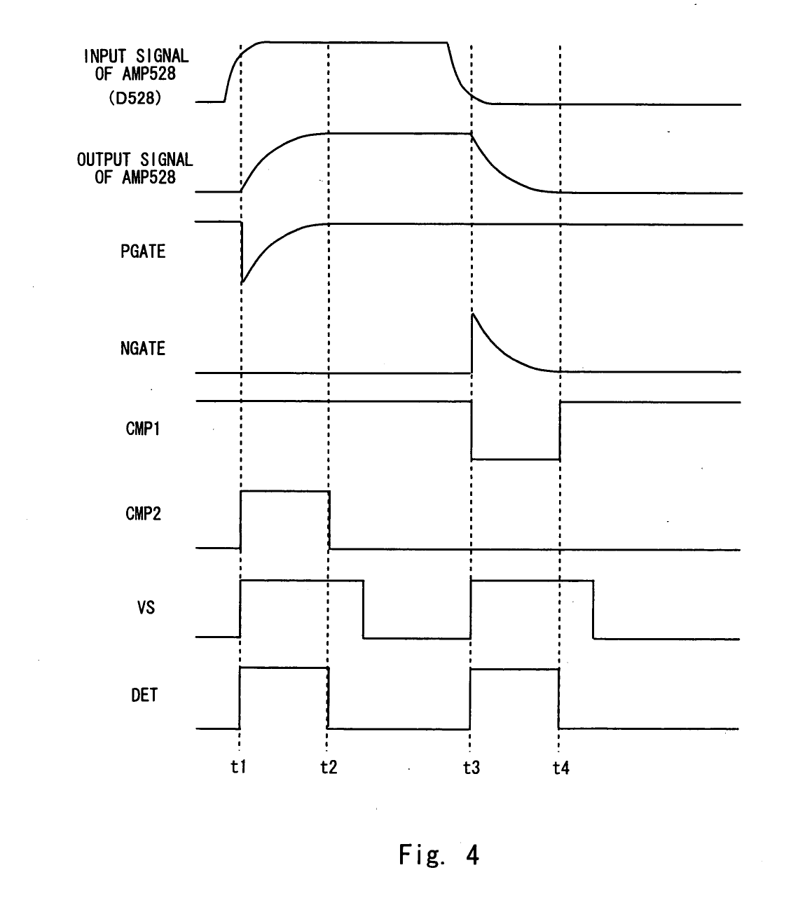

FIG. 4 shows an operation timing chart of such an output stage fluctuation detection circuit 113. As shown in FIG. 4, the amplifier control signal VS rises to a high level and remains at the high level for a predetermined period. Then, the amplifier control signal VSO, which is the output signal from the retention control circuit 114, rises. As a result, the bias current control circuit 111 is turned on and the amplifier AMP528 is also turned on. At this point, since the data input signal D528 has already risen to a high level, the output of the amplifier AMP528 has also already changed to the high-level side. Note that since the potential at the non-inverting input terminal has already changed to the high-potential side, the gate control signal PGATE from the differential amplification stage 130 falls so that the non-inverting input terminal and the inverting input terminal have the same potential. Since the gate sizes of the PMOS transistors MP121, MP122 and MP131 and NMOS transistors MN121, MN122 and MN131 have the relation expressed by the equations (1) and (2), both the operation signals CMP1 and CMP2 rise to a high level. As a result, the detection result signal DET becomes a high level.

At time t2, the potential difference between the non-inverting input terminal and the inverting input terminal becomes zero, and the gate control signal PGATE thereby returns to the normal state. Therefore, the operation signal CMP2 falls to a low level. Accordingly, although the amplifier control signal VS is at the high level, the detection result signal DET outputs a low level.

At time t3, the amplifier control signal VS falls and the amplifier control signal VSO, which is the output signal from the retention control circuit 114, rises. Since the data input signal D528 has already fallen to a low level, the potential at the non-inverting input terminal of the amplifier AMP528 has already changed to the low-level side. As a result, the gate control signal NGATE, which is the output signal from the differential amplification stage 130, rises so that the non-inverting input terminal and the inverting input terminal have the same potential.

Since the gate sizes of the PMOS transistors MP121, MP122 and MP131 and NMOS transistors MN121, MN122 and MN131 have the relation expressed by the equations (1) and (2), both the operation signals CMP2 and CMP1 fall to a low level. As a result, the detection result signal DET becomes a high level.

At time t4, the potential difference between the non-inverting input terminal and the inverting input terminal becomes zero, and the gate control signal PGATE thereby returns to the normal state. Therefore, the operation signal CMP1 rises to a high level. Accordingly, although the amplifier control signal VS is at the high level, the detection result signal DET outputs a low level.

In this way, by monitoring the gate control signals PGATE and NGATE of the output stage of the amplifier AMP528, it is possible to bring the detection result signal DET to a high level only when there is a potential difference between the non-inverting input terminal and the inverting input terminal. Therefore, the operating state of the amplifier AMP528 can be binarized as a detection result signal DET.

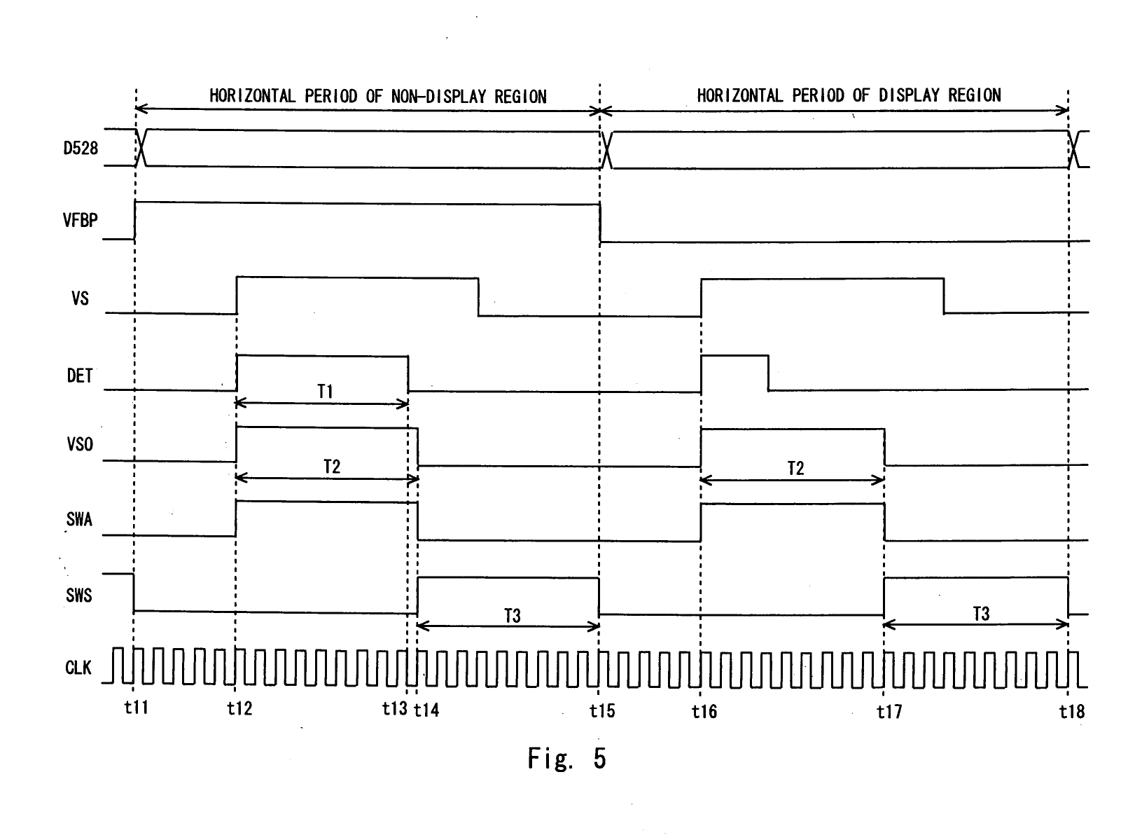

FIG. 5 shows an operation timing chart of a display control circuit 100 including an output stage fluctuation detection circuit 113 like this. In this timing chart, operations during one given horizontal synchronization period from a time t11 to a time t15 in a non-display region (first time region) and during one given horizontal synchronization period from a time t15 to a time t18 in a display region (second time region) are shown. Further, assume that the data signal D528 changes at a time t11, time t15, and time t18. Furthermore, the horizontal synchronization period from the time t11 to time t15 is repeated multiple times in the non-display region, and high-potential data and low-potential data are alternately selected as the data signal D528 for each horizontal synchronization period. The horizontal synchronization period from the time t15 to time t18 is repeated multiple times in the display region, and pixel data is selected based on the data signal D528.

As shown in FIG. 5, since a non-display region starts at a time t11, the mode signal VFBP becomes a high level. Further, the data signal D528 is input so that the output of the amplifier AMP528 has the largest amplitude.

At time t12, the amplifier control signal VS rises to a high level and remains at the high level for a predetermined period. Further, the amplifier control signal VSO, which is the output signal from the retention control circuit 114, becomes a high level. As a result, the bias current control circuit 111 and the amplifier AMP528 start to operate. Then, the detection result signal DET of the output stage fluctuation detection circuit 113 operates so as to follow the data signal D528 as explained above with reference to FIG. 2, and thereby becomes a high level. Further, the switch change signal generation circuit 112 raises the switch change signal SWA to a high level according to the amplifier control signal VSO.

At time t13, the potential difference between the non-inverting input terminal and the inverting input terminal of the amplifier AMP528 becomes zero as explained above with reference to FIG. 2, the detection result signal DET becomes a low level. Note that the period during which the detection result signal DET was a high level is defined as a period T1.

At time t14, the Low level of the detection result signal DET is reflected at the rising edge of the display clock CLK, and the amplifier control signal VSO thereby falls to a low level. In synchronization with this fall of the amplifier control signal VSO, the switch change signal SWA of the bias current control circuit 11 falls to a low level. Further, the switch change signal SWS rises a high level. Note that the retention control circuit 114 retains the period during which the amplifier control signal VSO is at a high level (time t12 to t14) as the number of clocks of the operating period of the amplifier AMP528 and the bias current control circuit 111. Further, this period is defined as a period T2.

At a time t15, the scanning line shifts from the non-display region to the display region. Further, the mode signal VFBP becomes a low level and pixel data of the data signal D528 is thereby selected. Note that in this case, the data signal D528 typically does not becomes such a signal that the output of the amplifier AMP528 applied at the time t11 in the non-display region has the largest amplitude. Therefore, the period during which the detection result signal DET is a high level usually becomes shorter than the above-described period T1.

At a time t16, similarly to the time t12, the amplifier control signal VS rises to a high level and the amplifier control signal VSO, which is the output signal from the retention control circuit 114, becomes a high level. As a result, the bias current control circuit 111 and the amplifier AMP528 start to operate. Note that the period T2 retained by the retention control circuit 114, during which the amplifier control signal VSO was a high level, is used for a period during which the amplifier control signal VSO is to be kept at a high level. Therefore, the bias current control circuit 111 and the amplifiers AMP1 to AMP528 operate for the period T2. By this operation, a gray-scale voltage(s) is written into a data line(s).

When the period T2 has elapsed from the time t16, the amplifier control signal VSO falls to a low level at a time T17. At this point, since the non-inverting input terminal and the inverting input terminal of the amplifier AMP528 have already become the same potential, the detection result signal DET is at a low level. Therefore, the amplifier AMP528 is turned off. Further, at the same moment as the amplifier control signal VSO falls to a low level, the switch change signal SWA also becomes a low level, and the switch circuits SWO1 to SWO528 are thereby turned off. Furthermore, the switch change signal SWS rises to a high level and remains at the high level for a predetermined period T3, and the switch circuits SWD1 to SWD528 are thereby turned on for this period. Therefore, the data input signals D1 to D528 are applied to the respective data lines of the color liquid crystal panel through the switch circuits SWD1 to SWD528, and the data is retained.

Note that the output circuit 1 in the prior art determines the writing capability of the amplifiers AMP1 to AMP528, which is the last stage of the display control circuit, by monitoring with the amplifier control signal selection circuit 13, which is the preceding stage thereof. Therefore, the writing time cannot be accurately detected, and therefore it is necessary to add the amount equivalent to the variations in the writing time of the amplifier to the operating time. Therefore, the shortest operating time for the writing operation of the amplifier cannot be obtained, and thus posing the problem that the current consumption cannot be minimized.

By contrast, the display control circuit 100 in accordance with a first exemplary embodiment includes the output stage fluctuation detection circuit 113 that detects output stage gate signals PGATE and NGATE of the amplifier AMP528. Further, the display control circuit 100 performs sampling by the internal clock CLK as the operating time T2 of the amplifier AMP528 and the amplifiers AMP1 to AMP527, each of which has the same configuration as that of the amplifier AMP528, according to the detection result of the output stage fluctuation detection circuit 113. Further, it also includes the retention control circuit 114 that stores the operating time T2 obtained by the sampling. Furthermore, it also includes the bias current control circuit 111 that is turned on/off by the signal VOS according to the operating time T2 output from the retention control circuit 114, and the switch change signal generation circuit 112 that generates switching signals SWA and SWS for the switch circuits SWO1 to SWO528 and SWD1 to SWD528.

With this configuration, in the non-display region, the data signal D528 that makes the output to the panel load have the largest amplitude is input to the non-inverting input terminal of the amplifier AMP528, and the panel load is thereby driven with that state. The output stage fluctuation detection circuit 113 determines a transient state and a stable state of the amplifier AMP528 based on the presence/absence of a potential difference between the non-inverting input terminal and the inverting input terminal, and outputs the determination result as a binarized signal DET. Further, it is possible to detect the delay amount of the amplifier AMP528, in which variations caused in manufacturing, variations in temperature, variations in power supply, and variations in panel load of the display control circuit 100 at the present state are taken into account, from the binarized output signal DET. This delay amount is retained in the retention control circuit 114 as the operating time T2 of the amplifiers AMP1 to AMP528 and the bias current control circuit 111 by the internal clock CLK of the display control circuit 100.

Further, in the display region, the amplifiers AMP1 to AMP528 and the bias current control circuit 111 are operated for the operating time T2, which was stored in the non-display region, so that the writing can be performed in the shortest operation time necessary to drive the panel load. Further, by suspending the amplifiers AMP1 to AMP528 and the bias current control circuit 111 after the writing operation, the current consumption of the display control circuit 100 can be minimized.

### Second Exemplary Embodiment

A specific second exemplary embodiment to which the present invention is applied is explained hereinafter with reference to the drawings. In this second exemplary embodiment, the present invention is applied to a display control circuit (drive circuit for display) of a liquid crystal display device as in the case of the first exemplary embodiment. However, unlike the first exemplary embodiment, the second exemplary embodiment is based on the assumption that the display control circuit is capable of performing high-speed data writing to a data line(s).

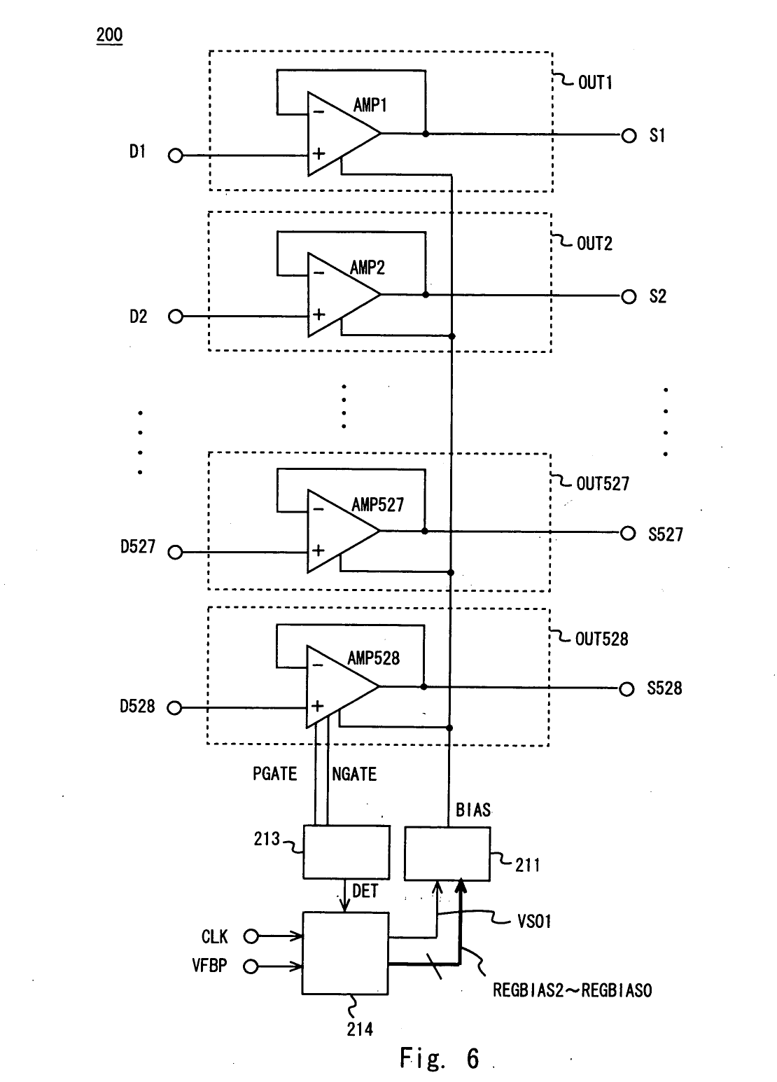

FIG. 6 shows an example of a configuration of a display control circuit 200 in accordance with this second exemplary embodiment. Note that similarly to the first exemplary embodiment, an example of a display control circuit capable of coping with 528 data lines (176×3 (red, green and blue)=528) of a color liquid crystal panel whose resolution is 176×220 pixels is described in this exemplary embodiment.

As shown in FIG. 6, a display control circuit 200 includes output units OUT1 to OUT528, a bias current control circuit 211, an output stage fluctuation detection circuit 213, and a retention control circuit 214. Note that among the signs shown in FIG. 6, the structures having the same signs as those of FIG. 1 are the same or similar structures as those of FIG. 1 unless stated otherwise.

Unlike the first exemplary embodiment, the output units OUT1 to OUT528 include respective amplifiers AMP1 to AMP528. The output units OUT1 to OUT528 have such a configuration that the switch circuits SWO1 to SWO528 and SWD1 to SWD528 are removed from the configuration of the first exemplary embodiment. Further, unlike the first exemplary embodiment, the switch change signal generation circuit is removed in the display control circuit 200. Furthermore, the amplifier control signal VS is also removed.

The inverting input terminals of the amplifiers AMP1 to AMP528 are connected to their own output terminals, and the non-inverting terminals thereof are connected to data input terminals D1 to D528. Further, the output terminals of the amplifiers AMP1 to AMP528 are also connected to data output terminals S1 to S528.

The output stage fluctuation detection circuit 213 has, basically, a similar configuration to that of the output stage fluctuation detection circuit 113 shown in FIG. 2. Further, its connection to the amplifier AMP528 is also similar to that of the output stage fluctuation detection circuit 113. However, since the amplifier control signal VS is removed, the AND circuit AND143 is removed from the detection circuit 120 of the output stage fluctuation detection circuit 213. Further, the output from the OR circuit OR142 serves as the detection result signal DET.

The retention control circuit 214 receives a detection result signal DET, a display clock CLK, and a mode signal VFBP. Similarly to the first exemplary embodiment, the display clock CLK is an internal clock used inside the display control circuit 200. The mode signal VFBP is at a high level in the display region. Further, the mode signal VFBP becomes a low level in the non-display region except for a specified period (period T2) (which is described later).

Further, the retention control circuit 214 outputs amplifier performance adjustment register signals REGBIAS2 to REGBIAS0 and an amplifier control signal VSO1. The amplifier performance adjustment register signals REGBIAS2 to REGBIAS0 are used to control the bias current value of the bias current control circuit 211 according to their signal values. However, when the mode signal VFBP is at a high level, the retention control circuit 214, as a function of the retention control circuit 214, does not change the values of the amplifier performance adjustment register signals REGBIAS2 to REGBIAS0. Further, the retention control circuit 114 includes a counter and the like, and can count the display clock CLK and store its count information.

The bias current control circuit 211 receives the amplifier performance adjustment register signals REGBIAS2 to REGBIAS0 from the retention control circuit 214. The bias current control circuit 211 can change the bias current value to the amplifiers AMP1 to AMP528 based on these amplifier performance adjustment register signals REGBIAS2 to REGBIAS0.

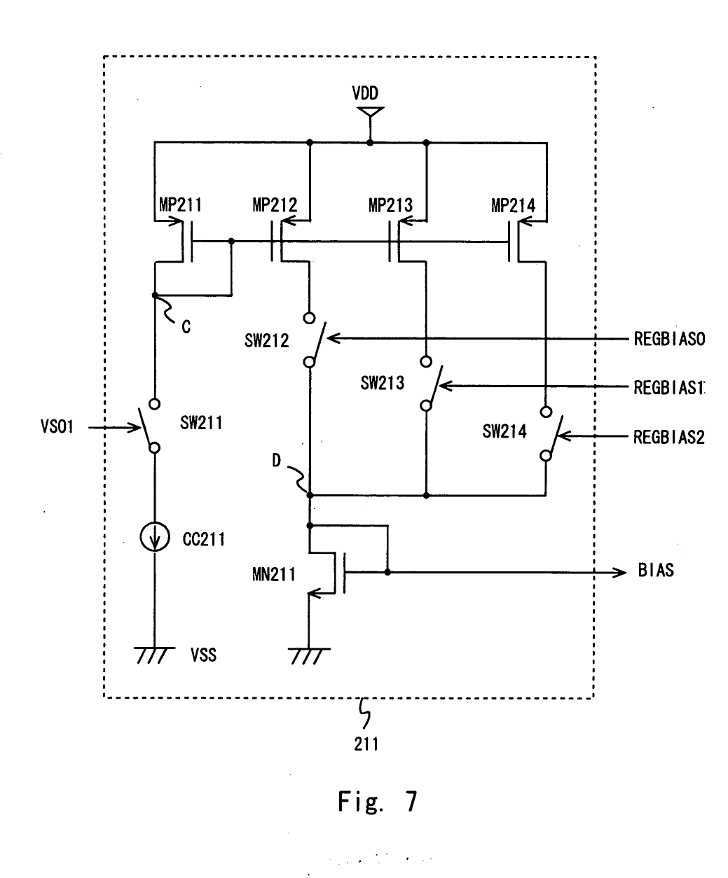

FIG. 7 shows a configuration of the bias current control circuit 211. As shown in FIG. 7, the bias current control circuit 211 includes PMOS transistors MP211 to MP214, an NMOS transistor MN211, switch circuits SW211 to SW214, and a constant current source CC211.

The source of the PMOS transistor MP211 is connected to a power-supply voltage terminal VDD, and the drain and gate are connected to a node C. The source of the PMOS transistor MP212 is connected to the power-supply voltage terminal VDD, and the drain is connected to one of the terminals of the switch circuit SW212. Further, the gate of the PMOS transistor MP212 is connected to the node C. The source of the PMOS transistor MP213 is connected to the power-supply voltage terminal VDD, and the drain is connected to one of the terminals of the switch circuit SW213. Further, the gate of the PMOS transistor MP213 is connected to the node C. The source of the PMOS transistor MP214 is connected to the power-supply voltage terminal VDD, and the drain is connected to one of the terminals of the switch circuit SW214. Further, the gate of the PMOS transistor MP214 is connected to the node C.

One of the terminals of the switch circuit SW211 is connected to the node C, and the other terminal is connected to the constant current source CC211. Further, the On-Off state of the switch circuit SW211 is controlled according to the amplifier control signal VSO1 from the retention control circuit 214. For example, it is turned on according to an amplifier control signal VSO1 having a high level. One of the terminals of the switch circuit SW212 is connected to the drain of the PMOS transistor MP212, and the other terminal is connected to a node D. Further, the On-Off state of the switch circuit SW212 is controlled according to the amplifier performance adjustment register signal REGBIAS2. For example, it is turned on according to an amplifier performance adjustment register signal REGBIAS2 having a high level.

One of the terminals of the switch circuit SW213 is connected to the drain of the PMOS transistor MP213, and the other terminal is connected to the node D. Further, the On-Off state of the switch circuit SW213 is controlled according to the amplifier performance adjustment register signal REGBIAS1. For example, it is turned on according to an amplifier performance adjustment register signal REGBIAS1 having a high level. One of the terminals of the switch circuit SW214 is connected to the drain of the PMOS transistor MP214, and the other terminal is connected to the node D. Further, the On-Off state of the switch circuit SW214 is controlled according to the amplifier performance adjustment register signal REGBIAS0. For example, it is turned on according to an amplifier performance adjustment register signal REGBIAS0 having a high level.

The drain and gate of the NMOS transistor MN211 are both connected to the node D, and the source is connected to a ground voltage terminal VSS. The node D serves as the output terminal of the bias current control circuit 211, and the current flowing to the node D serves as the bias current to the amplifiers AMP1 to AMP528. Note that the NMOS transistor MN211 adjusts the source current according to the load to which this bias current is supplied.

Note also that the above-described PMOS transistors MP212 to MP214 are connected with the PMOS transistor MP211 in a current mirror connection. Therefore, a current corresponding to the drain current of the PMOS transistor MP211 flows as the drain currents of the PMOS transistors MP212 to MP214. The total current of the drain currents of these PMOS transistors MP212 to MP214 flows to the node D. Further, as described above, the node D serves as the output terminal of the bias current control circuit 211. Therefore, as the current flowing to the node D changes, the bias current to the amplifiers AMP1 to AMP528 also changes.

Note that as described above, the switch circuits SW212 to SW214 are connected to the drains of the respective PMOS transistors MP212 to MP214 respectively. Therefore, the amount of the current flowing to the node D can be changed by the values of the amplifier performance adjustment register signals REGBIAS2 to REGBIAS0. For example, when the signals [REGBIAS2, REGBIAS1, REGBIAS0] are [0, 0, 0], the switch circuit SW212 to SW214 are all turned off and therefore almost no current flows to the node D. Therefore, the bias current output from the bias current control circuit 211 has the minimum value.

Further, when the signals [REGBIAS2, REGBIAS1, REGBIAS0] are [0, 0, 1], only the switch circuit SW212 is turned on and the drain current of the PMOS transistor MP212 thereby flows to the node D. The bias current corresponding to this drain current is output from the bias current control circuit 211. Further, when the signals [REGBIAS2, REGBIAS1, REGBIAS0] are [1, 1, 1], the switch circuit SW212 to SW214 are all turned on and therefore the drain currents of all the PMOS transistors MP212 to MP214 flow to the node D. Therefore, the bias current output from the bias current control circuit 211 has the maximum value.

Note that the constant current source CC211 determines the source current of the PMOS transistor MP211. Then, when the switch circuit SW211, which is connected between this constant current source CC211 and the PMOS transistor MP211, becomes an Off-state, the source currents of the PMOS transistors MP212 to MP214 are also stopped. That is, the amplifier control signal VSO1, which controls the On-Off state of the switch circuit SW211, also has a function of turning on/off the operation of the bias current control circuit 211.

Note that it is also possible to regard all of these bias current control circuit 211, output stage fluctuation detection circuit 213, and retention control circuit 214 as a single control circuit.

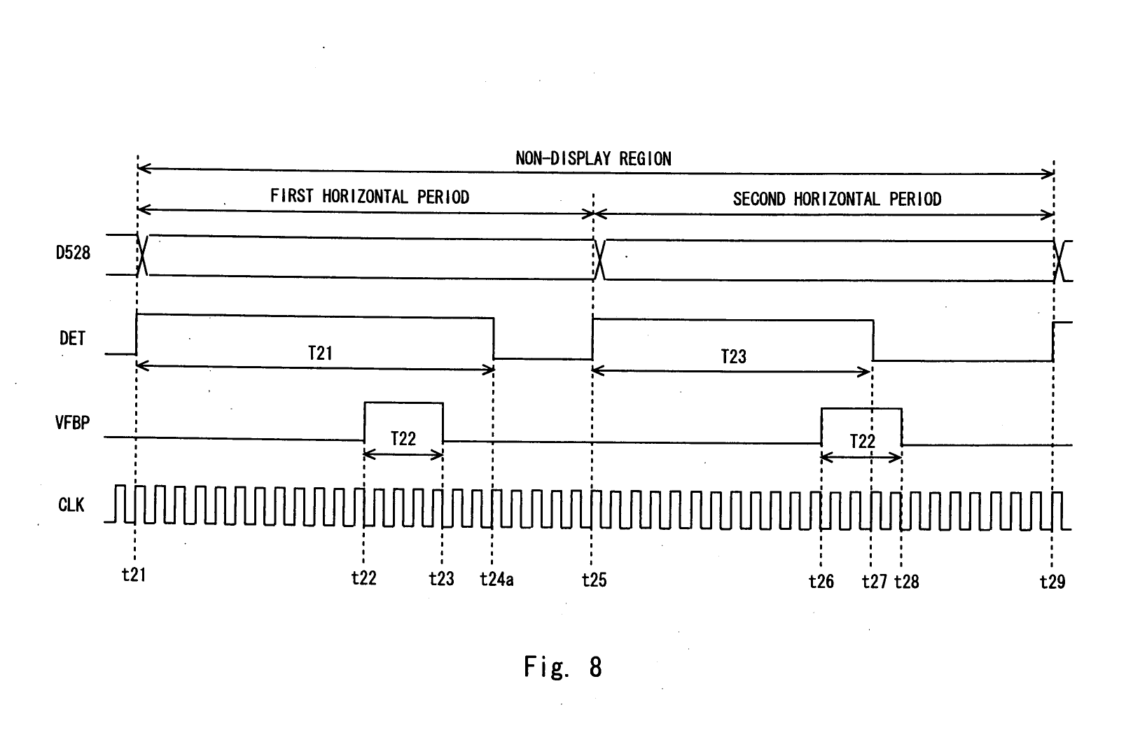

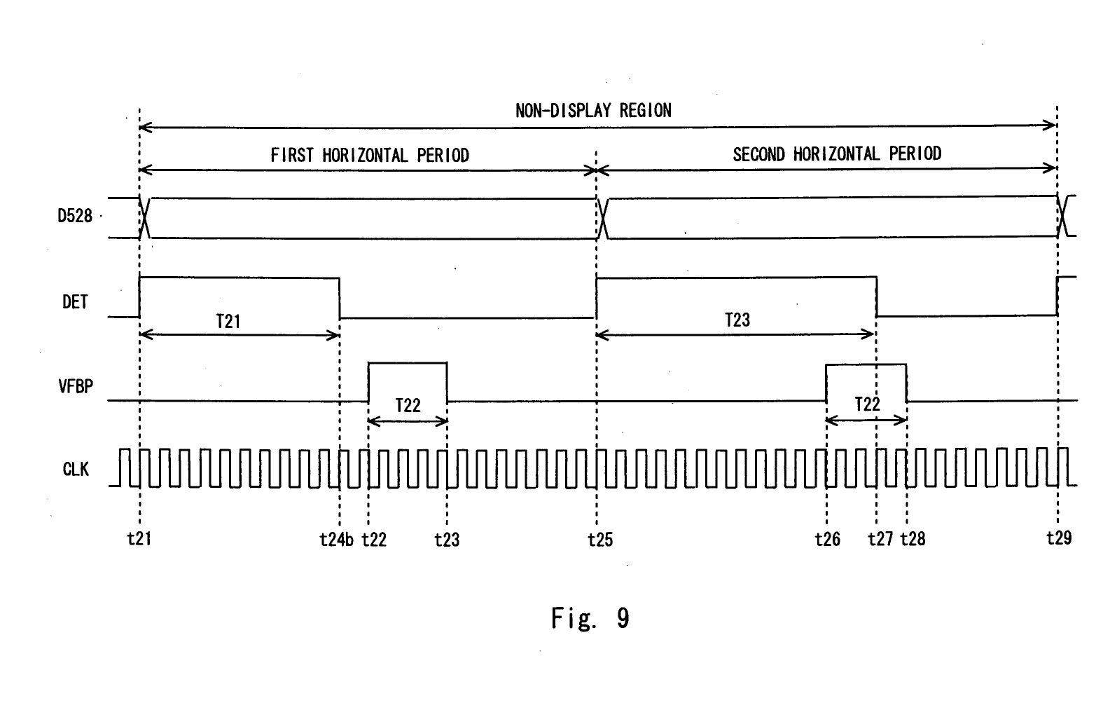

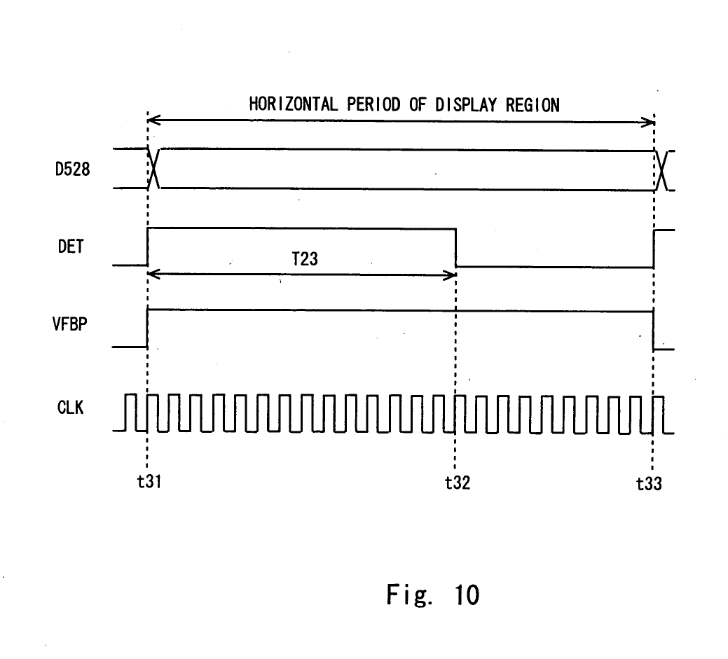

FIGS. 8, 9 and 10 show operation timing charts of the display control circuit 200 described above. The timing charts in FIGS. 8 and 9 show operations during given two consecutive horizontal synchronization periods (first and second horizontal synchronization periods) in a non-display region (first time region). The timing chart in FIG. 10 shows an operation during one horizontal synchronization period in a display region after the non-display region of FIG. 8 (or FIG. 9). Note that the horizontal synchronization period of the display region (second time region) in FIG. 10 is not necessarily located immediately after the two consecutive horizontal synchronization periods of FIG. 8 (or FIG. 9). Further, assume that the data signal D528 causes similar operations to those of the first exemplary embodiment. That is, the amplifier AMP528 receives such data signal D528 that the output of the amplifier AMP528 has the largest amplitude in one horizontal synchronization period in the non-display region.

Firstly, as shown in FIG. 8, a first horizontal synchronization period starts at a time t21. At this point, the mode signal VFBP is at a low level. Further, because of the change of the data signal D528, the detection result signal DET of the output stage fluctuation detection circuit 213 becomes a high level. Note that the retention control circuit 214 counts and stores the period T21 that extends until this detection result signal DET becomes a low level again as the number of display clocks CLKs. Further, though it is not shown, assume that the amplifier control signal VSO1 is at a high level and the amplifier performance adjustment resistors signals [REGBIAS2, REGBIAS1, REGBIAS0] are [0, 1, 1] at this point.

At a time t22, the mode signal VFBP becomes a high level, and it reaches the start time of the specified range (period T22). At this point, the detection result signal DET still remains at the high level.

At a time t23, the mode signal VFBP becomes a low level, and it reaches the end time of the specified range (period T22). At this point, the detection result signal DET still remains at the high level.

Next, the detection result signal DET becomes a low level at a time t24a. Note that the time t24a is located outside the specified range from the time t22 to time t23. Therefore, the period during which the detection result signal DET is at a high level is longer than the specified range. This means that the writing speed of the amplifier AMP528 is slow. Therefore, to increase the writing speed of the amplifier AMP528, the amplifier performance adjustment resistors signals [REGBIAS2, REGBIAS1, REGBIAS0] are set to [1, 1, 1] and the set values are stored. As a result, the bias current supplied to the amplifiers AMP1 to AMP528 increases. After that, the display control circuit 200 operates in this state.

Further, on the other hand, when the detection result signal DET changes to the low level at a time t24b that is earlier than the time t22 as shown in FIG. 9, it means that the writing speed of the amplifier AMP528 is fast. Therefore, to lower the writing speed of the amplifier AMP528, the amplifier performance adjustment resistors signals [REGBIAS2, REGBIAS1, REGBIAS0] are set to [0, 0, 1] and the set values are stored. As a result, the bias current supplied to the amplifiers AMP1 to AMP528 decreases. After that, the display control circuit 200 operates in this state.

At a time t25, similarly to the time t21, because of the change of the data signal D528, the detection result signal DET of the output stage fluctuation detection circuit 213 becomes a high level. Note that the retention control circuit 214 counts and stores the period T23 that extends until this detection result signal DET becomes a low level again as the number of display clocks CLKs.

At a time t26, similarly to the time t22, the mode signal VFBP becomes a high level, and it reaches the start time of the specified range (period T22). At this point, the detection result signal DET still remains at the high level. At a time t27, the amplifier AMP528 operates with the bias current that was explained above with reference to the time t24a (or time t24b). Therefore, the detection result signal DET becomes a low level before the mode signal VFBP becomes a low level. At a time t28, the mode signal VFBP becomes a low level, and similarly to the time t23, it reaches the end time of the specified range (period T22).

Note that the time t27 at which the detection result signal DET becomes a low level is located within the specified range from the time t26 to time t28 as described above. Therefore, the values of the amplifier performance adjustment resistors signals REGBIAS2 to REGBIAS0 are retained without being changed at the time t27. After that, the display control circuit 200 operates in this state. Then, the next horizontal synchronization period starts at a time t29. Further, the retention control circuit 214 stores this period from the time t25 to t27 as the number of clocks of the operating period of the amplifier AMP528 and the bias current control circuit 211. Further, this period is defined as a period T23.

Next, as shown in FIG. 10, a display region start at a time t31. The mode signal VFBP becomes a low level, and pixel data of the data signal D528 is selected. Then, the detection result signal DET is brought to and maintained at a high level for the number of clocks of the above described period T23 stored in the retention control circuit 214. In this way, the bias current control circuit 211 and the amplifiers AMP1 to AMP528 operate for the period T23. By this operation, a gray-scale voltage(s) is written into a data line(s).

When the period T23 has elapsed from the time t31, the detection result signal DET falls to a low level at a time T32. As a result, the operations of the bias current control circuit 211 and the amplifiers AMP1 to AMP528 are stopped. Then, the next horizontal synchronization period starts at a time t33.

Note that the high level period of the detection result signal DET according to the data signal D528 input at the time t31 and the above-described high level period of the detection result signal DET in the non-display region change. However, since the mode signal VFBP is fixed at the high level in the display region, the retention control circuit 214 does not update the set values of the amplifier performance adjustment resistors signals REGBIAS2 to REGBIAS0.

As described above, the second exemplary embodiment is based on the assumption that display control circuit 200 is capable of performing the high-speed writing to a data line(s). Note that it is conceivable that in the first exemplary embodiment, the amplifiers AMP1 to AMP528 and the bias current control circuit 111 cannot be actively turned on/off. However, in the display control circuit 200 in accordance with this second exemplary embodiment, even in the case like this, the delay amount of the amplifier AMP528 is detected and the bias current is changed based on its detection result. Then, the panel load can be driven by the amplifiers AMP1 to AMP528 operating with the changed bias current. Therefore, the amplifiers AMP1 to AMP528 can be operated with the minimum bias current, and thus enabling the current consumption of the display control circuit 200 to be minimized.

### Third Exemplary Embodiment

A specific third exemplary embodiment to which the present invention is applied is explained hereinafter with reference to the drawings. In this third exemplary embodiment, the present invention is applied to a display control circuit (drive circuit for display) of a liquid crystal display device as in the case of the first and second exemplary embodiments. However, unlike the first exemplary embodiment, the third exemplary embodiment is based on the assumption that the display control circuit is capable of performing high-speed data writing to a data line(s).

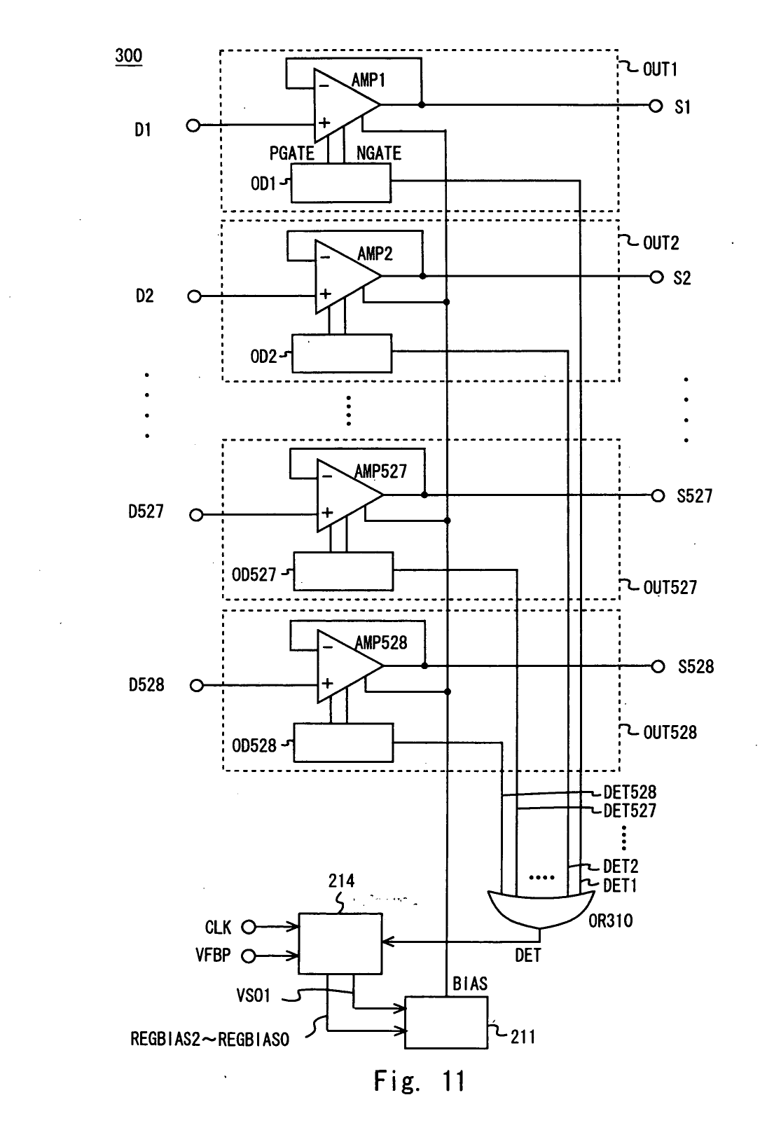

FIG. 11 shows an example of a configuration of a display control circuit 300 in accordance with this third exemplary embodiment. Note that similarly to the first and second exemplary embodiments, an example of a display control circuit capable of coping with 528 data lines (176×3 (red, green and blue)=528) of a color liquid crystal panel whose resolution is 176×220 pixels is described in this exemplary embodiment.

As shown in FIG. 11, a display control circuit 300 includes output units OUT1 to OUT528, a bias current control circuit 211, a retention control circuit 214, and an OR circuit OR310. Note that among the signs shown in FIG. 11, the structures having the same signs as those of FIG. 6 are the same or similar structures as those of FIG. 6 unless stated otherwise.

The output units OUT1 to OUT528 include respective output stage fluctuation detection circuits OD1 to OD528 and amplifiers AMP1 to AMP528, unlike the second exemplary embodiment, the output units OUT1 to OUT528 have such a configuration that the output stage fluctuation detection circuits OD1 to OD528 are connected to the respective amplifiers AMP1 to AMP528.

Note that the configuration of each of the output stage fluctuation detection circuits OD1 to OD528 is basically similar to that of the output stage fluctuation detection circuit 113 explained above with reference to FIG. 2. Further, the connection relation between each of the amplifiers AMP1 to AMP528 and the respective one of the output stage fluctuation detection circuits OD1 to OD528 is basically similar to that shown in FIG. 2, and therefore explanation of the configuration and operation thereof is omitted here. However, the detection result signals output from the output stage fluctuation detection circuits OD1 to OD528 are defined as signals DET1 to DET528 respectively.

These detection result signals DET1 to DET528 are input to the OR circuit OR310. The OR circuit OR310 calculates the logical sum of the detection result signals DET1 to DET528. Then, it outputs the calculation result to the retention control circuit 214 as a detection result signal DET. The retention control circuit 214 and the bias current control circuit 211 are similar to those of the second exemplary embodiment, and therefore their explanation is omitted.

Note that it is also possible to regard all of these bias current control circuit 211, output stage fluctuation detection circuits OD1 to OD528, retention control circuit 214, and OR circuit OR310 as a single control circuit.

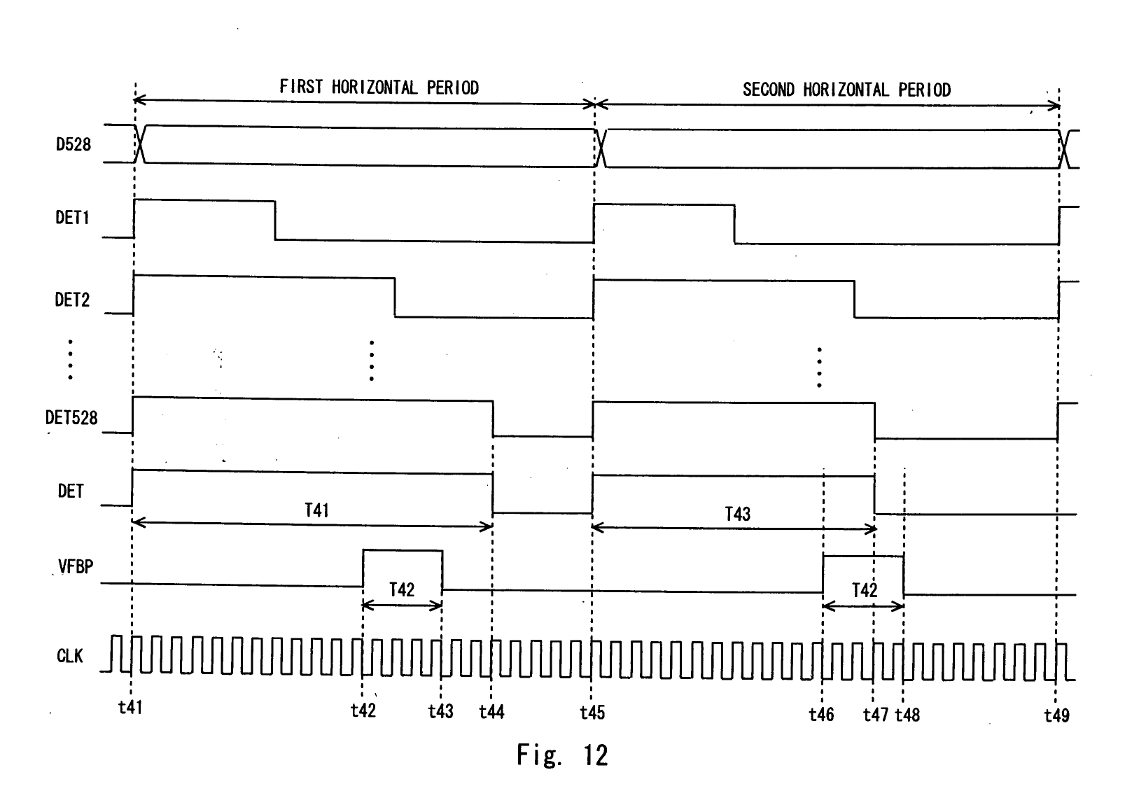

FIG. 12 shows an operation timing chart of the display control circuit 300 described above. The timing chart in FIG. 12 shows operations during given two consecutive horizontal synchronization periods (first horizontal synchronization period (first time region) and second horizontal synchronization period (second time region)). Note that the durations from a time t42 to time t43 and from a time t46 to time t48 are defined as “specified range” in a similar manner to that explained in the second exemplary embodiment, and the specified range (period T42) is established near the end of one horizontal synchronization period.

Firstly, as shown in FIG. 12, a first horizontal synchronization period starts at a time t41. At this point, the mode signal VFBP is at a low level. Data signals D1 to D528 are input to the respective amplifiers AMP1 to AMP528. Then, the detection result signals DET1 to DET528 of the output stage fluctuation detection circuits OD1 to OD528 rise to a high level. Note that unlike the data signal D528 applied in the non-display region of the first and second exemplary embodiments, the above-mentioned data signals D1 to D528 have various values. Therefore, the output signals of the respective amplifiers AMP1 to AMP528 also have various voltage variation amounts. Therefore, the periods during which the respective detection result signals DET1 to DET528 of the output stage fluctuation detection circuits OD1 to OD528 are at high levels also have various lengths.

Note that the detection result signals DET1 to DET528 are input to the OR circuit OR310 and the logical sum of these signals serves as the detection result signal DET. Therefore, the high level period of the detection result signal DET is determined according to one (or more than one) of the detection result signals DET1 to DET528 having the longest high level period. The retention control circuit 214 counts and stores the high level period T41 of this detection result signal DET as the number of display clocks CLKs. Further, though it is not shown, assume that the amplifier control signal VSO1 is at a high level and the amplifier performance adjustment resistors signals [REGBIAS2, REGBIAS1, REGBIAS0] are [0, 1, 1] at this point.

At a time t42, the mode signal VFBP becomes a high level, and it reaches the start time of the specified range (period T42). At this point, the detection result signal DET still remains at the high level. At a time t43, the mode signal VFBP becomes a low level, and it reaches the end time of the specified range (period T42). At this point, the detection result signal DET still remains at the high level.

Next, all the detection result signals DET1 to DET528 become a low level at a time t44. Note that the time t44 is located outside the specified range from the time t42 to time t43. Therefore, the period during which the detection result signal DET is at a high level is longer than the specified range. This means that the writing speed of the amplifier AMP528 is slow. Therefore, to increase the writing speed of the amplifiers AMP1 to AMP528, the amplifier performance adjustment resistors signals [REGBIAS2, REGBIAS1, REGBIAS0] are set to [1, 1, 1] and the set values are stored. As a result, the bias current supplied to the amplifiers AMP1 to AMP528 increases. After that, the display control circuit 300 operates in this state.

Further, on the other hand, when the detection result signal DET changes to the low level before the time t42, it means that the writing speed of the amplifiers AMP1 to AMP528 is fast. Therefore, to lower the writing speed of the amplifiers AMP1 to AMP528, the amplifier performance adjustment resistors signals [REGBIAS2, REGBIAS1, REGBIAS0] are set to [0, 0, 1] and the set values are stored. As a result, the bias current supplied to the amplifiers AMP1 to AMP528 decreases.

At a time t45, similarly to the time t41, because of the change of the data signals D1 to D528, the detection result signal DET output from the OR circuit OR310 becomes a high level. Note that the retention control circuit 214 counts and stores the period T43 that extends until this detection result signal DET becomes a low level again as the number of display clocks CLKs. Note that at the time t45, the set values [1, 1, 1] that were set at the time t44 are retained as the amplifier performance adjustment resistors signals REGBIAS2 to REGBIAS0.

At a time t46, similarly to the time t42, the mode signal VFBP becomes a high level, and it reaches the start time of the specified range (period T42). At this point, the detection result signal DET still remains at the high level. At a time t47, the amplifiers AMP1 to AMP528 operate with the bias current that was explained above with reference to the time t44. Therefore, the detection result signal DET becomes a low level before the mode signal VFBP becomes a low level. At a time t48, the mode signal VFBP becomes a low level, and similarly to the time t43, it reaches the end time of the specified range (period T42).

Note that the time t47 at which the detection result signal DET becomes a low level is located within the specified range from the time t46 to time t48 as described above. Therefore, the values of the amplifier performance adjustment resistors signals REGBIAS2 to REGBIAS0 are retained without being changed at the time t47. After that, the display control circuit 300 operates in this state. Then, the next horizontal synchronization period starts at a time t49. Further, the retention control circuit 214 stores this period from the time t45 to t47 as the number of clocks of the operating period of the amplifiers AMP1 to AMP528 and the bias current control circuit 211. Then, it is also used in a subsequent horizontal synchronization period(s).

As described above, the third exemplary embodiment is based on the assumption that display control circuit 300 is capable of performing the high-speed writing to a data line(s) as in the case of the second, exemplary embodiment. Note that it is conceivable that in the first exemplary embodiment, the amplifiers AMP1 to AMP528 and the bias current control circuit 111 cannot be actively turned on/off. However, in the display control circuit 300 in accordance with this third exemplary embodiment, even in the case like this, the delay amount of the amplifiers AMP1 to AMP528 is detected and the bias current is changed based on its detection result. Then, the panel load can be driven by the amplifiers AMP1 to AMP528 operating with the changed bias current. Therefore, the amplifiers AMP1 to AMP528 can be operated with the minimum bias current, and thus enabling the current consumption of the display control circuit 300 to be minimized. Further, unlike the second exemplary embodiment, the above-described detection operation can be performed not only in the non-display region but also for each of any given horizontal synchronization periods. Therefore, the conforming ability can be further improved in comparison to the second exemplary embodiment, and thus further reducing the current consumption.

Note that the present invention is not limited to the above-described exemplary embodiments, and various modifications can be made without departing from the spirit and scope of the present invention. For example, in the second and third exemplary embodiments, the bias current control circuit 211 is controlled by the 3-bit amplifier performance adjustment register signal for increasing/decreasing the bias current. However, the bias current control circuit 211 may be controlled by m-bit amplifier performance adjustment register signal (m>3). However, in this case, the bias current control circuit 211 includes m switch circuits that receive m-bit amplifier performance adjustment register signal, and m PMOS transistors for constant current sources connected to those switch circuits. Further, although the number of pixels on the horizontal side is 173×3=528, this number of pixels can be increased or decreased.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

The first to third exemplary embodiments can be combined as desirable by one of ordinary skill in the art.

What is claimed is:

1. A display control circuit for a display comprising:
a plurality of amplifiers connected to data lines of a display panel, the plurality of amplifiers being configured to apply a gray-scale voltage to the data lines when a bias current is supplied; and
a control circuit that supplies a bias current to the amplifiers,
wherein the control circuit detects an operating state of at least one amplifier among the plurality of amplifiers that operates by the bias current in a first time region, and causes the plurality of amplifiers to operate by supplying the bias current for a predetermined period according to the detection result in a second time region after the first time region.

2. The display control circuit for a display according to claim 1, wherein the control circuit comprising:
a bias current control circuit that supplies the bias current;
a detection circuit that detects an operating state of one given first amplifier among the plurality of amplifiers; and
a retention control circuit that retains a detection result of the detection circuit according to an operating state of the first amplifier that operated in the first time region, and causes the bias current control circuit to operate for a predetermined period according to the retained detection result in the second time region.

3. The display control circuit for a display according to claim 2, wherein
the first amplifier constitutes a voltage follower,
the detection circuit outputs a detection signal as the detection result according to a gate control signal used to control an output transistor of the amplifier, and
the retention control circuit retains time information of the predetermined period according to a period during which the detection signal is output in the first time region.

4. The display control circuit for a display according to claim 3, wherein
the first time region is a horizontal synchronization period in which a panel pixel driven by a data line to which the first amplifier is connected is a non-display state, and
the second time region is a horizontal synchronization period in which a panel pixel driven by a data line to which the amplifier is connected is displayed.

5. The display control circuit for a display according to claim 4, further comprising:
first switch circuits connected between output terminals of the plurality of amplifiers and data lines corresponding to the respective output terminals; and
a switch control circuit that controls an On-Off state of the first switch circuits according to a control signal from the retention control circuit,
wherein the switch control circuit puts the first switch circuits in an On-state for the predetermined period in the second time region, the predetermined period being retained as time information by the retention control circuit.

6. The display control circuit for a display according to claim 5, further comprising second switch circuits connected between input terminals from which a data signal is input to the plurality of amplifiers and data lines, wherein
the switch control circuit has a function of controlling an On-Off state of the second switch circuits according to a control signal from the retention control circuit, and
the switch control circuit brings the second switch circuits to an On-state after the predetermined period has elapsed in the second time region.

7. The display control circuit for a display according to claim 4, wherein
the bias current control circuit has a function of changing a current amount of a bias current by a register signal output from the retention control circuit,
in a first horizontal synchronization period in the first time region, the retention control circuit changes a value of the register signal so that a period during which the detection signal is output ends within a predefined time range, and retains its value, and
in a second horizontal synchronization period after the first horizontal synchronization period of the first time region, the retention control circuit determines a period during which the detection signal according to a current amount of a bias current of the bias current control circuit by the retained register signal value is output as time information of the predetermined period.

8. The display control circuit for a display according to claim 1, wherein
the control circuit comprises:
a bias current control circuit that supplies the bias current;
a plurality of detection circuits, each of which detects an operating state of respective one of the plurality of amplifiers; and
a retention control circuit that retains time information based on a detection result from the plurality of the detection circuits according to an operating state of the plurality of amplifiers that operated in the first time region, and causes the bias current control circuit to operate only for a predetermined period according to the retained time information in the second time region.

9. The display control circuit for a display according to claim 8, further comprising a calculation circuit, wherein
each of the plurality of amplifiers constitutes a voltage follower,
each of the plurality of detection circuits outputs a detection signal according to a gate control signal used to control an output transistor of respective one of the plurality of amplifiers,
the calculation circuit performs a calculation according detection signals from the plurality of detection circuits, and
the retention control circuit retains time information of the predetermined period according to an operating period of the plurality of detection circuits calculated from a calculation result of the calculation circuit.

10. The display control circuit for a display according to claim 9, wherein
the bias current control circuit has a function of changing a current amount of a bias current by a register signal output from the retention control circuit,
in the first time region, the retention control circuit changes a value of the register signal so that an operating period of the plurality of detection circuits calculated from a calculation result of the calculation circuit ends within a predefined time range, and retains its value, and
in the second time region after the first time region, the retention control circuit determines an operating period of the plurality of detection circuits calculated from a calculation result of the calculation circuit obtained by performing a calculation on the detection signal according to a current amount of a bias current of the bias current control circuit by the retained register signal value as time information of the predetermined period.

11. The display control circuit for a display according to claim 10, each of the first and second time regions is a horizontal synchronization period.
